(19) United States
(12) Patent Application Publication
(10) Pub. No.: US 2010/0203210 A1
(43) Pub. Date: Aug. 12, 2010

(54) TOMATO SWEET INFUSION PROCESS

(75) Inventors: Cesar Corona, Newman, CA (US); Tim McGill, San Francisco, CA (US); Robert Benech, San Francisco, CA (US)

Correspondence Address: KELLY LOWRY & KELLEY, LLP, 6320 CANOGA AVENUE, SUITE 1650, WOODLAND HILLS, CA, 91367, US

(73) Assignee: VSP PRODUCTS, INC., Newman, CA (US)

(21) Appl. No.: 12/367,902

(22) Filed: Feb. 9, 2009

(51) Int. Cl. A23B 7/02

(52) U.S. Cl. 426/442; 426/456

(57) ABSTRACT

A tomato sweet infusion process involves heating sliced tomato sections in a bath of high fructose corn syrup, water, citric acid and ascorbic acid. The tomato sections in the bath are subjected to cycles of negative pressure and atmospheric pressure and then spread on a drying tray. The tomato sections are dehydrated to a moisture content of between twelve and twenty percent, preferably between fourteen percent and eighteen percent.

### FIELD OF THE INVENTION

The present invention relates to a process for preparing tomato sections for consumption. More particularly, the present invention relates to a process for dehydrating tomato sections and infusing those sections with a sweetener.

### BACKGROUND OF THE INVENTION

It is well known in the art that dehydrated products offer numerous advantages with respect to the original natural products, such as a more prolonged preservation of quality, more efficient transportation and storage without refrigeration, less storage space per unit of solids, and considerable decrease in transportation costs per unit of solids.

Dried foods are a popular snack food item. Besides being tasty, dried fruits and vegetables contain many vitamins and minerals. Consequently, in comparison to many other snack foods, dried foods provide a healthy alternative. However, one problem that has existed with regard to dried foods of this nature is that they have usually undergone a treatment in order to control the enzymatic and non-enzymatic processes and also to slow down or inhibit any microbiological activity therein. Treatment processes such as sulfiting consist of treating the food with sulfur dioxide or similar compounds such as sulfurous acid salts. Many consumers do not want to consume foods that have undergone a sulfiting treatment, for health reasons.

Furthermore, there exists a need to infuse dried foods, particularly tomatoes and similar foods, with a sweetening agent. Methods of infusing fruits with fructose sugar solids and food products which remain non crystalline at freezer temperatures containing such infused fruit products are disclosed in U.S. Pat. No. 4,350,711. This patent discloses immersion of the fruit in two or more sugar containing solute baths of gradually increasing sugar concentration. Another method of infusing fruits with sugar solutes, including fructose solutes, is disclosed in U.S. Pat. No. 4,234,611. This patent discloses the use of a single sugar containing bath to accomplish the infusion process.

Accordingly, there is a need for an improved tomato sweet infusion process whereby tomatoes may be sweetened. There is also a need for an improved process whereby tomatoes can be dehydrated without undergoing a sulfiting treatment. The present invention fulfills these needs and provides other related advantages.

### SUMMARY OF THE INVENTION

The present invention is directed to a tomato sweet infusion process beginning with slicing a tomato into sections. The tomato may be washed first and the sections may comprise quarters.

A batch formulation of high fructose corn syrup, water, citric acid and ascorbic acid is then mixed together. This batch formulation is heated to at least 140° F. and may be heated to 160° F. or higher. The sliced tomato sections are then added to the heated batch formulation and the batch formulation with the tomato sections is reheated to the target temperature. The batch formulation with tomato sections may or may not be cooled at this point. If cooled, the batch formulation with tomato sections is cooled for at least three to seven minutes, preferably five minutes.

The batch formulation with tomato sections is then subjected to a negative pressure, preferably a vacuum. The negative pressure may be from twenty to thirty psi for at least five minutes. Preferably, the negative pressure is at twenty-five psi for at least ten minutes. At this point, the negative pressure on the batch formulation with tomato sections may be released and held at atmospheric pressure for three to seven minutes and then resubjected to negative pressure as described above.

After the batch formulation with tomato sections is subjected to a negative pressure cycle, the batch formulation with tomato sections is spread on a wooden drying tray. A release agent may be applied to the drying tray beforehand. The batch formulation with tomato sections is then dehydrated so that the tomato sections have a moisture content of twelve to twenty percent. After the dehydration is completed, a release agent may be applied to the tomato sections.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow chart illustrating a preferred embodiment of the inventive process; and

FIG. 2 is a flow chart illustrating an alternate embodiment of the inventive process.

### DETAILED DESCRIPTION OF THE PREFERRED EMBODIMENTS

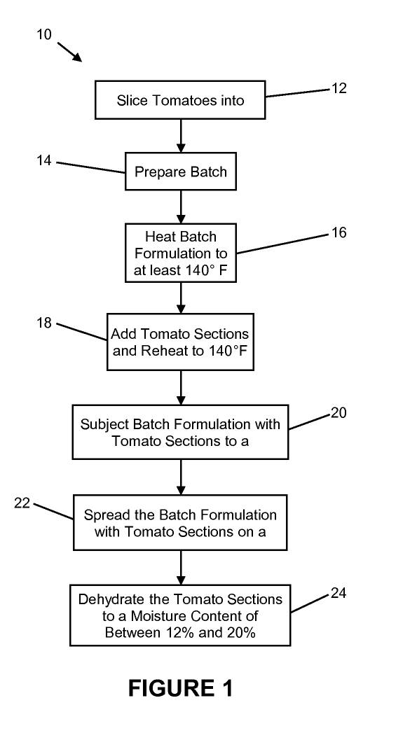

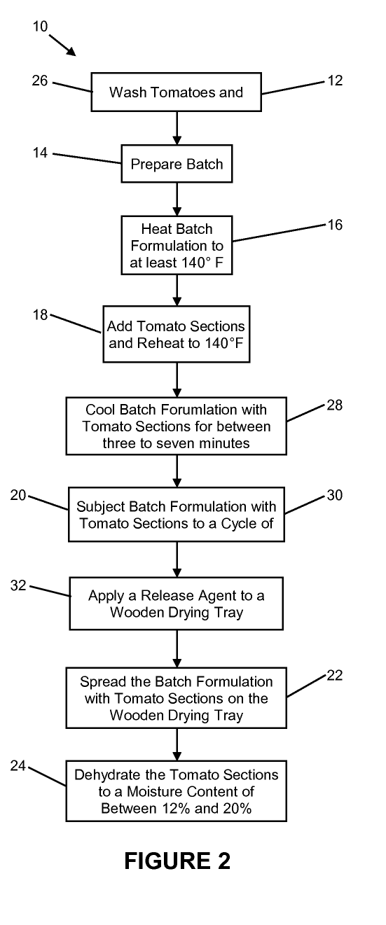

The present invention relates to a process for infusing tomatoes with a sweetening agent and producing a sweetened dehydrated tomato section. The inventive process, generally referred to by reference numeral 10 in FIGS. 1 and 2, presents a novel way of preparing sweet infused, dehydrated tomatoes.

In a preferred embodiment, depicted in FIG. 1, the tomato sweet infusion process 10 begins with the step of slicing 12 one or more tomatoes into sections. The sections may comprise quarters or some other portion of a whole tomato that provides a convenient or appropriate bite size. According to the process 10, after the tomatoes are sliced, one must mix 14 a batch formulation. The batch formulation includes 50.0% high fructose corn syrup, 49.4% water, 0.4% citric acid and 0.2% ascorbic acid. The batch formulation is then heated 16 to at least 140° F. Preferably, the batch formulation is heated 16 to 160° F. as this provides for greater infusion of the sweeteners into the tomato sections. The tomato sections are then added 18 to the heated batch formulation, which is then reheated 18 to the previously achieved temperature.

The batch formulation with tomato sections is then subjected 20 to a negative pressure, i.e., pressure below atmospheric pressure. As with the heating, the negative pressure is designed to cause more of the sweetener to infuse into the tomato sections. The negative pressure may comprise from between twenty and thirty psi for a period of at least five minutes. Preferably, the negative pressure is at twenty-five psi for a period of at least ten minutes.

Next, the batch formulation with tomato sections is spread 22 on a wooden drying tray. The wooden drying tray is then placed in a dehydrator and the tomato sections are dehydrated 24 to a moisture content of between twelve percent and twenty percent, preferably between fourteen percent and eighteen percent. At this point, the tomato sections have been infused with the sweetener and dehydrated such that the process 10 is completed.

In an alternate embodiment illustrated in FIG. 2, the same steps are performed with some additional steps included. Initially, the tomatoes may be washed 26 prior to slicing 12. The batch formulation is then mixed 14 as described above. The formulation is then heated 16 with the tomato sections added and then reheated 18 as described above. The reheated batch formulation is then allowed to cool 28 for between three to seven minutes.

Subsequently, the batch formulation is then subjected 20 to a negative pressure as described above. Following this application of negative pressure, the batch formulation is then subjected 30 to a cycle of atmospheric and negative pressures. Preferably, the batch formulation is held at atmospheric pressure for three to seven minutes and then re-subjected to a negative pressure. The second application of negative pressure may be performed at twenty to thirty psi for at least five minutes and preferably at twenty-five psi for at least ten minutes.

A release agent is applied 32 to the wooden drying tray before the batch formulation is spread 22 on the wooden drying tray and placed in a dehydrator. The tomato sections are dehydrated 24 to a moisture content of between twelve percent and twenty percent, preferably between fourteen percent and eighteen percent. After the dehydration is completed, another release agent may be applied to the tomato sections prior to removal from the drying tray.

Although multiple embodiments have been described in detail for purposes of illustration, various modifications may be made without departing from the scope and spirit of the invention. Accordingly, the invention is not to be limited, except as by the appended claims.

What is claimed is:

1. A tomato sweet infusion process, comprising the steps of:
slicing a tomato into sections;
mixing a batch formulation including high fructose corn syrup, water, citric acid and ascorbic acid;
heating the batch formulation to at least 140 degrees Fahrenheit;
adding the tomato sections to the heated batch formulation;
reheating the batch formulation with tomato sections to at least 140 degrees Fahrenheit;
subjecting the batch formulation with tomato sections to negative pressure; and
dehydrating the batch formulation with tomato sections to a moisture content of 12-20%.

2. The process of claim 1, wherein during the heating and reheating steps, the batch formulation is heated to at least 160 degrees Fahrenheit.

3. The process of claim 1, further comprising the steps of washing the tomato and slicing the tomato into quarters.

4. The process of claim 1, further comprising the step of cooling the batch formulation before the subjecting step.

5. The process of claim 4, wherein the cooling step lasts three to seven minutes.

6. The process of claim 5, wherein the cooling step lasts five minutes.

7. The process of claim 1, wherein the subjecting step is performed at 20-30 psi for at least five minutes.

8. The process of claim 7, wherein the subjecting step is performed at 25 psi for at least ten minutes.

9. The process of claim 1, further comprising the steps of:
releasing the negative pressure on the batch formulation with tomato sections;
holding the batch formulation with tomato sections at atmospheric pressure for three to seven minutes; and
resubjecting the batch formulation with tomato sections to negative pressure.

10. The process of claim 9, wherein the subjecting and resubjecting steps are performed at 20-30 psi for at least five minutes.

11. The process of claim 10, wherein the subjecting and resubjecting steps are performed at 25 psi for at least ten minutes and the negative pressure comprises a vacuum.

12. The process of claim 1, further comprising the step of spreading the batch formulation with tomato sections on a drying tray before the dehydrating step.

13. The process of claim 12, wherein the drying tray is wooden.

14. The process of claim 12, further comprising the step of applying a release agent to the drying tray before the spreading step.

15. The process of claim 1, further comprising the step of applying a release agent to the batch formulation with tomato sections after the dehydrating step.

16. A tomato sweet infusion process, comprising the steps of:
slicing a tomato into sections;
mixing a batch formulation including high fructose corn syrup, water, citric acid and ascorbic acid;
heating the batch formulation to at least 140 degrees Fahrenheit; adding the tomato sections to the heated batch formulation;
reheating the batch formulation with tomato sections to at least 140 degrees Fahrenheit;
cooling the batch formulation with tomato sections for three to seven minutes;
subjecting the batch formulation with tomato sections to negative pressure of 20-30 psi for at least five minutes; and
dehydrating the batch formulation with tomato sections to a moisture content of 12-20%.

17. The process of claim 16, wherein during the heating and reheating steps, the batch formulation is heated to at least 160 degrees Fahrenheit.

18. The process of claim 16, wherein the cooling step lasts five minutes and the subjecting step is performed at 25 psi for at least ten minutes.

19. The process of claim 16, further comprising the steps of:
releasing the negative pressure on the batch formulation with tomato sections;
holding the batch formulation with tomato sections at atmospheric pressure for three to seven minutes; and
resubjecting the batch formulation with tomato sections to negative pressure.

20. The process of claim 19, wherein the subjecting and resubjecting steps are performed at 25 psi for at least ten minutes and the negative pressure comprises a vacuum.

21. The process of claim 16, further comprising the steps of applying a release agent to a wooden drying tray and spreading the batch formulation with tomato sections on the drying tray prior to the dehydrating step.
